(19) United States
(12) Patent Application Publication
(10) Pub. No.: US 2026/0270266 A1
(43) Pub. Date: Sep. 10, 2026

(54) METHODS AND SYSTEMS FOR DATA COMMUNICATION BETWEEN NETWORK DEVICES

(71) Applicant: Pismo Labs Technology Limited, Kowloon (HK)

(72) Inventor: Wan Chun LEUNG, Kowloon (HK)

(73) Assignee: Pismo Labs Technology Limited, Kowloon (HK)

(21) Appl. No.: 18/849,499

(22) PCT Filed: Oct. 5, 2023
(86) PCT No.: PCT/IB2023/059992

§ 371 Date: Sep. 21, 2024

(51) Int. Cl. H04L 9/40

(52) U.S. Cl. CPC H04L 63/101; H04L 63/0227

(57) ABSTRACT

A method and system for transmitting data packets between a first network device and a second network device. The second network device first establishes at least one first connection with a first node of the selected cloud, and the first network device may establish at least one second connection with a second node of the selected cloud with an access code. The access code is generated by the second network device locally when the at least one first connection is established. When a first data packet is transmitted from the first network device to the second network device through the cloud, the data packet is deemed a data packet sent by the second network device.

### TECHNICAL FIELD

The present invention generally relates to transmitting data packets through a virtual private network (VPN) connection. More specifically, the present invention relates to accessing an end device through the VPN connection without being blocked.

### SUMMARY OF INVENTION

One exemplary embodiment of the present invention discloses a method and system for transmitting data packets from a first network device located in a first location to a second network device located in a second location through a selected cloud. An edge server is located in the second location such that data packets received by the edge server are deemed transmitted from the second network device.

In one embodiment, the first network device and the second device connected to different available nodes of the selected cloud.

In another embodiment, the first network device and the second device connected to the same available node of the selected cloud.

According to one of the embodiments of the present invention, access control is applied at the second network device such that not all devices with access code are able to establish a connection with a node of the selected cloud.

According to the present invention, methods and systems for selecting a cloud and selecting a node are disclosed herein. The node selection may be performed by either the network devices or the cloud.

According to one of the embodiments of the present invention, VPN ID is applied during data packet transmission.

### Technical Problem

Tunneled traffic networks (“TTNs”) refer to a type of network architecture where data is encapsulated within another data packet and transmitted over a public or untrusted network. VPNs are a common example of TTNs. They were developed to allow companies with multiple physical locations to create a secure and single enterprise network that is transparent to the user.

Some service providers, including streaming service providers, take various means to avoid a massive number of users attempting to connect to the same host with the same source Internet Protocol (“IP”) address for considerations such as network security, licensing agreements with the third party, geo-restriction enforcement, server load management, and commercial reasons. When using VPN for the streaming service, if a massive number of users attempt to connect to the same host through the same proxy server, then same source IP address can be detected and blocked by the streaming service providers.

For example, if a TV programme provided by a streaming service provider is only available in the United States, a user located in France may establish a VPN connection for watching the TV programme even if he or she is not in the United States. If the connected IP address is detected by the service provider to conclude that VPN is used, then the VPN connection will be blocked. The VPN connection may be detected by various means, such as IP address blacklisting, DNS mismatch, and traffic patterns.

Some VPN providers attempt to work around this by continually updating the servers' IP addresses to evade blockages by the streaming service providers and allow their users to access overseas contents. Nevertheless, this is not a panacea for solving the problem because service providers tend to keep updating their blacklist.

The present invention discloses methods and systems for accessing a designated end device in another location, such that the data packets received from the designated end device are deemed transmitted from the IP address of the network interface of the relay server.

### BRIEF DESCRIPTION OF DRAWINGS

FIG. 1A illustrates a schematic block diagram of an exemplary network environment operable to establish at least one tunnel between two network devices.

FIG. 1B illustrates a schematic block diagram of an exemplary network environment of three clouds.

FIG. 2A illustrates the block diagram of a network device according to one embodiment of the present invention.

FIG. 2B illustrates the block diagram of a network device according to one embodiment of the present invention.

FIG. 2C illustrates the block diagram of a network device according to one embodiment of the present invention.

FIG. 3 is a process flowchart illustrating a method for establishing a tunnel with a cloud and generating an access code according to an embodiment of the present invention.

FIG. 4 is a process flowchart illustrating a method for establishing a tunnel with a cloud using an access code according to an embodiment of the present invention.

FIG. 5 is a process flowchart illustrating a method the implementation of access control according to an embodiment of the present invention.

FIG. 6 is a timing diagram illustrating the connection between two network devices of an exemplary embodiment of the present invention.

FIG. 7A illustrates data packets according to an embodiment of the present invention.

FIG. 7B illustrates data packets according to an embodiment of the present invention.

### DESCRIPTION OF EMBODIMENTS

The terminology used herein is for the purpose of describing particular embodiments only and is not intended to be limited to example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

As used herein, the terms “computer-readable medium”, “main memory”, “secondary storage medium”, or “other storage mediums” refers to any medium that participates in providing instructions to a processing unit for execution. The processing unit reads the data written in the primary storage medium and writes the data in the secondary storage medium. Therefore, even if the data written in the primary storage medium is lost due to a momentary power failure and the like, the data can be restored by transferring the data held in the secondary storage medium to the primary storage medium. Computer-readable medium is just one example of a machine-readable medium, which carries instructions for implementing any of the methods and/or techniques described herein. Such a medium may take many forms, including but not limited to, non-volatile media, volatile media, and transmission media. Non-volatile media includes, for example, optical or magnetic disks. Volatile storage includes dynamic memory. Transmission media includes coaxial cables, copper wire and fiber optics. Transmission media can also take the form of acoustic or light waves, such as those generated during radio-wave and infrared data communications.

A volatile storage may be used for storing temporary variables or other intermediate information during execution of instructions by a processing unit. A non-volatile storage or static storage may be used for storing static information and instructions for the processor, as well as various system configuration parameters.

The storage medium may include a number of software modules that may be implemented as software codes to be executed by the processing unit using any suitable computer instruction type. The software code may be stored as a series of instructions or commands, or as a program in the storage medium.

Various forms of computer-readable media may be involved in carrying one or more sequences of one or more instructions to the processor for execution. For example, the instructions may initially be carried on a magnetic disk from a remote computer. Alternatively, a remote computer can load the instructions into its dynamic memory and send the instructions to the system that runs one or more sequences of one or more instructions.

A processing unit may be a microprocessor, a microcontroller, a digital signal processor (DSP), any combination of those devices, or any other circuitry configured to process information.

A processing unit executes program instructions or code segments for implementing embodiments of the present invention. Furthermore, embodiments may be implemented by hardware, software, firmware, middleware, microcode, hardware description languages, or any combination thereof. When implemented in software, firmware, middleware or microcode, the program instructions to perform the necessary tasks may be stored in a computer readable storage medium. A processing unit(s) can be realized by virtualization, and can be a virtual processing unit(s) including a virtual processing unit in a cloud-based instance.

The techniques described herein may be used for various wireless communication networks such as Code Division Multiple Access (“CDMA”), Time Division Multiple Access (“TDMA”), Frequency Division Multiple Access (“FDMA”), Orthogonal Frequency Division Multiple Access (“OFDMA”), Single Carrier Frequency Division Multiple Access (“SC-FDMA”) and other networks. The terms “network” and “system” are often used interchangeably. A CDMA network may implement radio technology such as Universal Terrestrial Radio Access (“UTRA”), CDMA2000, etc. UTRA includes Wideband CDMA (“WCDMA”) and other variants of CDMA. CDMA2000 covers IS-2000, IS-95 and IS-856 standards. A TDMA network may implement radio technology such as Global System for Mobile Communications (“GSM”). An OFDMA network may implement a radio technology such as Evolved UTRA (“E-UTRA”), Ultra Mobile Broadband (“UMB”), IEEE 802.11 (Wi-Fi), IEEE 802.16 (WiMAX), IEEE 802.20, Flash-OFDM, etc. UTRA and E-UTRA are part of Universal Mobile Telecommunication System (“UMTS”). 3GPP Long Term Evolution (“LTE”) is a UMTS that uses E-UTRA, which employs OFDMA on the downlink and SC-FDMA on the uplink. 3GPP stands for “3rd Generation Partnership Project”, which is an organization that publishes documents to describe UTRA, E-UTRA, UMTS, LTE and GSM and “3rd Generation Partnership Project 2” (“3GPP2”) documents describe CDMA 2000 and UMB.

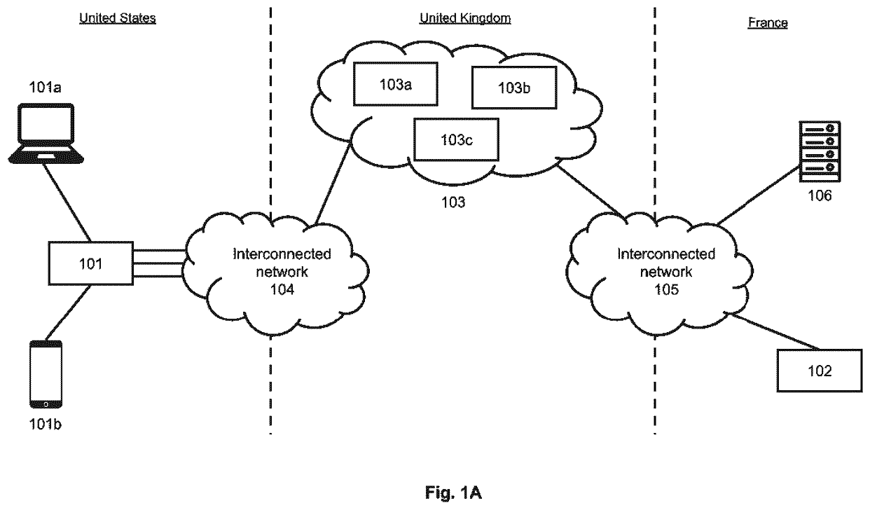

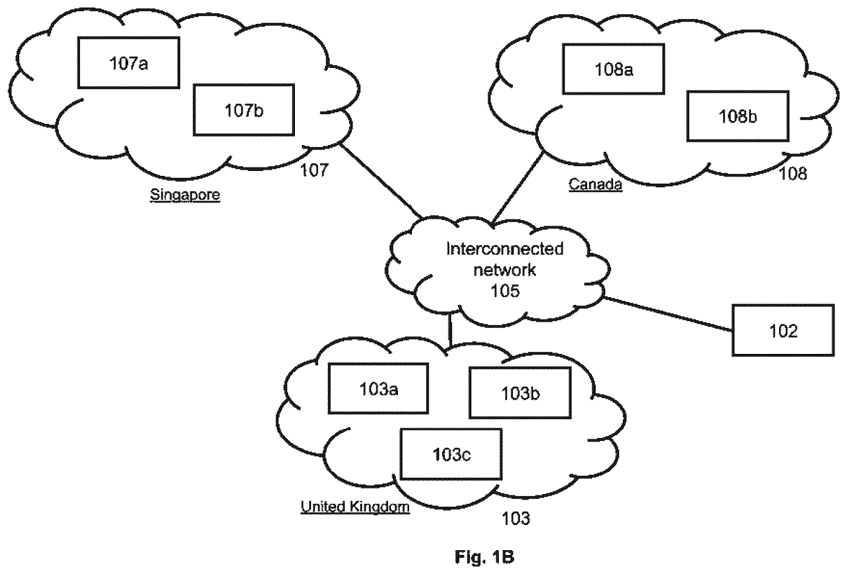

FIG. 1A is a schematic block diagram illustrating an exemplary network environment operable to establish at least one tunnel between network devices, a selected cloud, and end devices in accordance with the embodiments disclosed herein. The apparatuses of FIG. 1A comprise relay client 101, relay server 102, and cloud 103, each of them located in a different location. There may be more than one available cloud comprising at least one node for selection. For illustrative purposes, only one cloud, such as cloud 103, with three available nodes 103a, 103b, and 103c, is shown as the selected cloud.

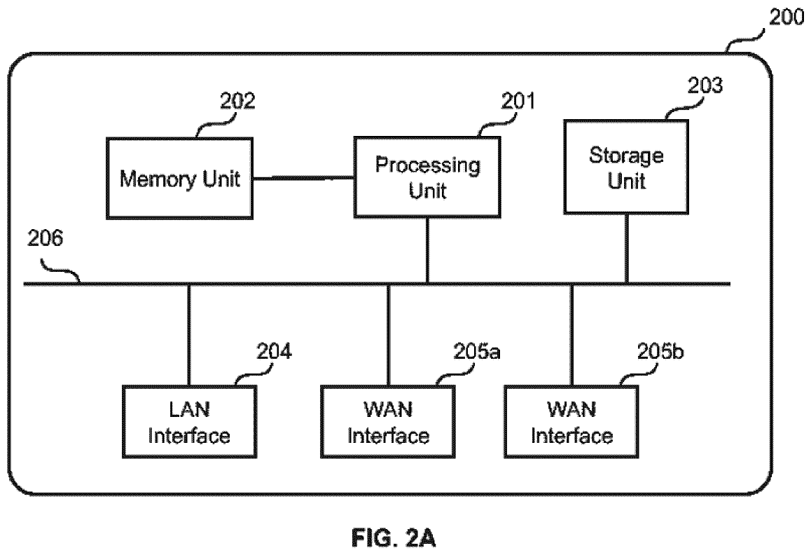

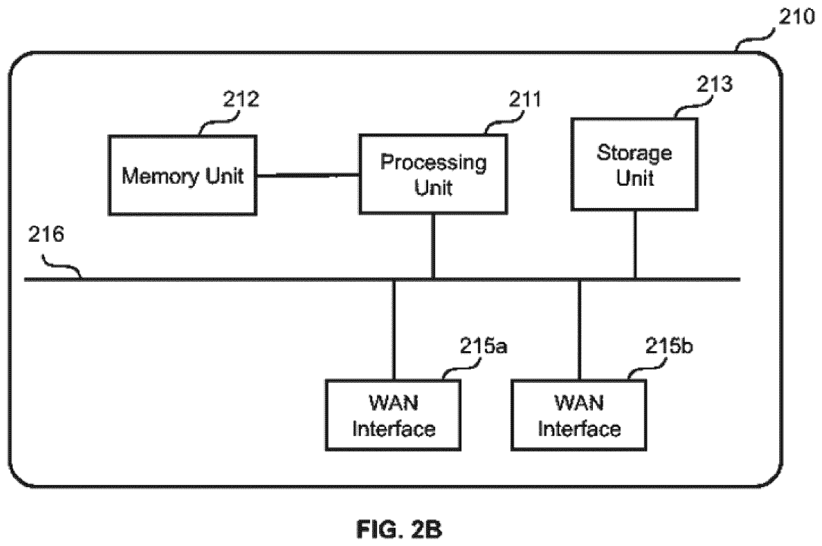

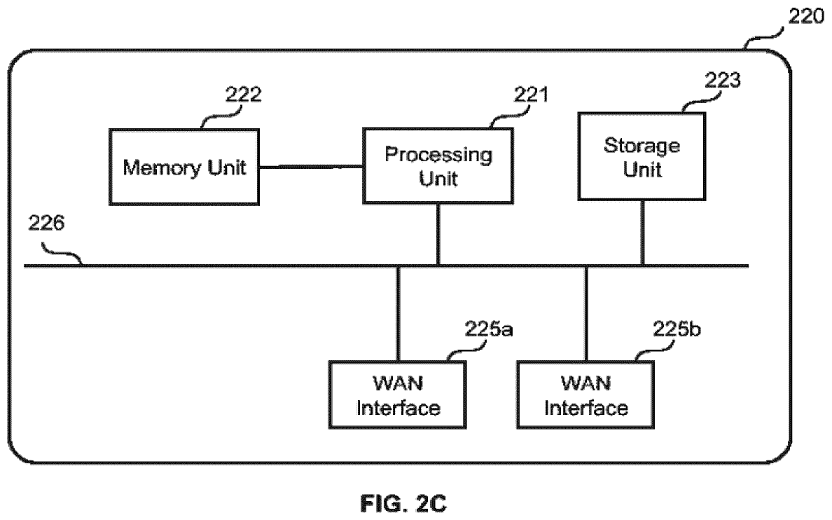

For illustrative purposes, relay client 101, relay server 102, and cloud 103 are located in the United States, France, and the United Kingdom respectively, and exhibit functional parallels with network device 200, management server 210, and network device 220, as demonstrated in FIG. 2A, FIG. 2B, and FIG. 2C respectively.

Laptop 101a and mobile 101b are connected to relay client 101 locally, and relay client 101 may communicate with a first node of cloud 103 through a first interconnected network, such as interconnected network 104. Edge server 106 and relay server 102 may communicate with a second node of cloud 103 through a second interconnected network, such as interconnected network 105. The first Interconnected network and the second interconnected network may be a public network, a private network, or a combination of public and private networks, such as intranet, extranet, and internet.

In one embodiment, the first node and the second node are the same node.

In another embodiment, the first node and the second node are different nodes, which may communicate with each other.

In one embodiment, the first node and the second node are on the same network subnet and communicate with each other directly.

In another embodiment, the first node and the second node are not on the same network subnet and communicate with each other indirectly.

In one embodiment, at least one first communication link is established between at least one network interface of relay client 101 and interconnected network 104, and at least one second communication link is established between at least one network interface of relay server 102 and interconnected network 105. Therefore, relay client 101 may establish at least one first Wide Area Network (“WAN”) connection to interconnected network 104 through the at least one first communication link and relay server 102 may establish at least one second WAN connection to interconnected network 105 through the at least one second communication link. Finally, relay client 101 may establish at least one first connection to the first node of cloud 103 through interconnected network 104, and further establish at least one first tunnel to the node through the established at least one first connection; and relay server 102 may establish at least one second connection to the second node of cloud 103 through interconnected network 105, and further establish at least one second tunnel to the node through the established at least one second connection.

In one variant, interconnected network 104 and interconnected network 105 are the same interconnected network, such as the Internet.

To illustrate the process described in the present invention, there are some prerequisites as to the location of the device. Relay server 102 should be located in the same region, county, or country (collectively referred to as “location” hereafter) as edge server 106, but in a different location from relay client 101. For example, as shown in FIG. 1A, both relay server 102 and edge server 106 are in France.

In one embodiment, node 103a is located in the same location as relay client 101. For example, node 103a and relay client 101 both are located in the United States, as shown in FIG. 1A.

In another embodiment, node 103a is located in the same location as relay server 102 and edge server 106. For example, node 103a, relay server 102, and edge server 106 are located in France, as shown in FIG. 1A.

For simplification, only one server is shown in FIG. 1A. It is possible that more than one server is connected to the interconnected network such that relay server 102 may select a management server.

There is no limitation on where relay client 101, relay server 102, and node 103a must be located. The reference to the United States, France, and the United Kingdom in FIG. 1A is purely for illustrative purposes and does not imply any specific requirements or limitations.

As mentioned, there may be more than one available cloud for relay server 102 to be selected. FIG. 1B is a schematic of an exemplary network environment illustrating how relay server 102 selects a cloud from the available clouds. As illustrated in FIG. 1B, the available clouds are clouds 103, 107, and 108, which are reachable through interconnected network 105. For illustrative purposes, clouds 103 with nodes 103a-103c, 107 with nodes 107a-107c, and 108 with nodes 108a-108c are the clouds located in the United Kingdom, Singapore, and Canada respectively.

In one embodiment, the user or the administrator of relay server 102 may select a cloud from the available clouds according to a first criterion, and establish a connection with the second node of the selected cloud. The second node is selected according to a second criterion. The first criterion and the second criterion may be selected from one or more of the following: latency, packet size, processing rate, location, cost, time, availability, security, and features that the node can perform, such as load balancing.

In one variant, the cloud and/or the second node are randomly selected.

For example, cloud 103 is randomly selected from clouds 103, 107, and 108, and the second node is selected according to latency. Assuming that the latency of available nodes 103a, 103b, and 103c are 3 ms, 10 ms, and 22 ms respectively, node 103a with the least latency will therefore be selected as the second node.

In another variant, the first criterion may depend on the second criterion. For example, if the cloud is to be selected according to latency, then the latency of the cloud is the latency of a node of the cloud with the least latency.

For example, clouds 103, 107 and 108 are with latencies of 3 ms, 10 ms, and 22 ms respectively. If the latency is the only consideration of the first criterion, it is preferable for the user or the administrator of relay server 102 to select cloud 103 for establishing the at least one second tunnel, which has the least latency.

In another embodiment, the cloud may be selected according to the proximity with the relay server. For example, as clouds 103, 107, and 108 are located in the United Kingdom, Singapore, and Canada respectively, relay server 102 located in France may select cloud 103, which is the nearest cloud from relay server 102, for establishing the at least one connection.

FIG. 2A illustrates a schematic block diagram of network device 200 according to one of the embodiments of the present invention. Network device 200 comprises processing unit 201, main memory 202, storage unit 203, at least one network interface, such as local area network (“LAN”) interface 204, and WAN interfaces 205a and 205b. Processing unit 201 is connected to main memory 202.

Processing unit 201 is connected to storage unit 203, at least one LAN interface 204, and WAN interfaces 205a and 205b via bus 206. Processing unit 201 executes program instructions or code segments for implementing embodiments of network device 200. In one embodiment, main memory 202 and storage unit 203 are non-transitory computer-readable storage media. In another embodiment, storage unit 203 is a non-volatile storage. A non-volatile storage or static storage can be used for storing static information and instructions for processing units, as well as various system configuration parameters. Storage unit 203 can be configured to store a firmware. Firmware can be an operating system of network device 200.

In one variant, network device 200 may further comprise at least one modem for connecting at least one SIM for establishing a cellular connection.

In another variant, network device 200 may further comprise an embedded Universal Integrated Circuit Card (“eUICC”) for establishing a cellular connection by managing the eSIMs within the eUICC to provide access to wireless services for network device 200.

FIG. 2B illustrates a schematic block diagram of management server 210 according to one of the embodiments of the present invention. Similar to network device 200 in FIG. 2A, management server 210 comprises processing unit 211, main memory 212, storage unit 213, and at least one network interface, for example, WAN interfaces 215a and 215b. Processing unit 201 is connected to main memory 212.

Processing unit 211 is connected to storage unit 213, and WAN interfaces 215a and 215b via bus 216. Processing unit 211 executes program instructions or code segments for implementing embodiments of management server 210. Main memory 212 and storage unit 213 are non-transitory computer-readable storage media. In another embodiment, storage unit 213 is non-volatile storage. A non-volatile storage or static storage can be used for storing static information and instructions for processing units, as well as various system configuration parameters. Storage unit 213 can be configured to store firmware. A firmware can be an operating system of management server 210.

In one preferred embodiment, management server 210 is managed by a person, company, or organization other than the owner of network devices 200 and 220. For example, the manufacturer manages a plurality of management servers in different locations, such as Japan, the United States, and the United Kingdom.

In another embodiment, management server 210 is managed by the same owner of network devices 200 and 220.

FIG. 2C illustrates a schematic block diagram of network device 220 according to one of the embodiments of the present invention. Network device 220 comprises processing unit 221, main memory 222, storage unit 223, and at least one network interface, for example, WAN interfaces 225a and 225b. Processing unit 221 is connected to main memory 222.

Processing unit 221 is connected to storage unit 223, and WAN interfaces 225a and 225b via bus 226. Processing unit 221 executes program instructions or code segments for implementing embodiment operations of network device 220. Main memory 222 and storage unit 223 are non-transitory computer-readable storage media. In another embodiment, storage unit 223 is a non-volatile storage. A non-volatile storage or static storage can be used for storing static information and instructions for processing units, as well as various system configuration parameters. Storage unit 223 can be configured to store firmware. The firmware can be an operating system of network device 220.

In one variant, network device 220 may further comprise at least one modem for connecting at least one SIM for establishing a cellular connection as a connection.

In another variant, network device 220 may further comprise an eUICC for establishing a cellular connection by managing the eSIMs within the eUICC to provide access to wireless services for network device 220.

There is no limitation on the number of WAN interfaces on network device 200, management server 210, or network device 220. The more WAN interfaces that network device 200, management server 210 or network device is equipped with, the more connections may be formed. For example, if network device 200 comprises five WAN interfaces and management server 210 comprises six WAN interfaces, thirty connections may be formed between network device 200 and management server 210. Therefore, the number of WAN interfaces shown in FIG. 2A, FIG. 2B, and FIG. 2C are for illustrative purposes only.

There is no limitation on the number of LAN interfaces on network device 200, management server 210, or network device 220. The more LAN interfaces that network device 200, management server 210, or network device 220 is equipped with, the more end devices may be connected to network device 200, management server 210, or network device 220. Therefore, the number of LAN interfaces shown in FIG. 2A, FIG. 2B, and FIG. 2C are for illustrative purposes only.

In one variant, the LAN interface(s) on network device 200 may be supported to be used as WAN interface(s) for establishing WAN connection(s).

In one embodiment, network device 220 is capable of performing a series of functions for establishing at least one first connection between the cloud and the relay server, and establishing at least one second connection between the cloud and the relay client respectively. The series of functions include but are not limited to one or more of the following: establishing a tunnel, generating an access code, and performing access control locally and/or remotely.

In one variant, if network device 220 is not capable of performing the series of functions, it is possible that an external controller may be plugged into network device 220 to perform the series of functions.

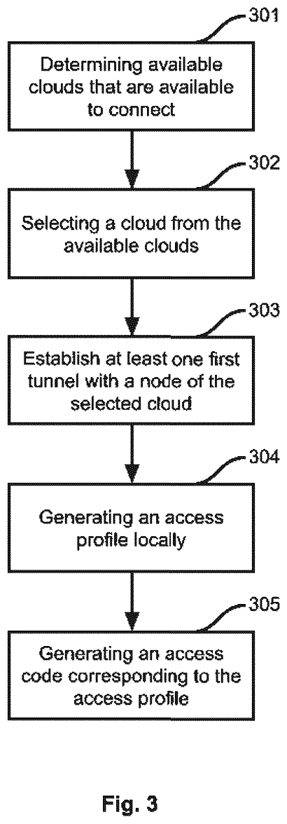

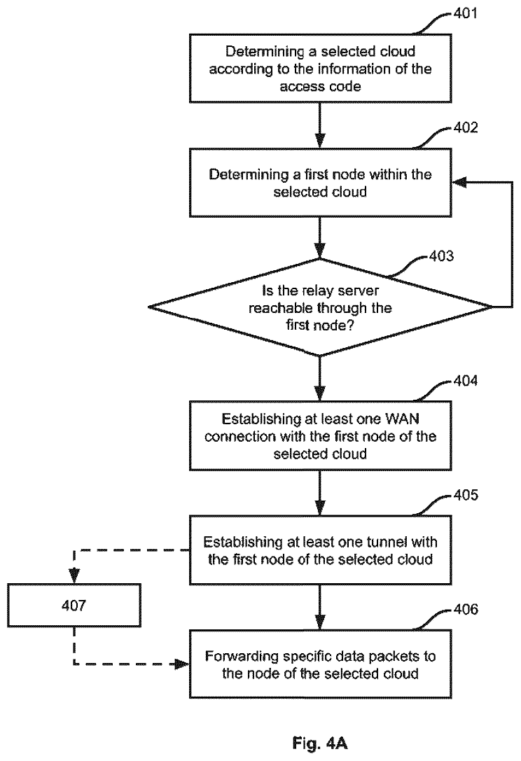

FIG. 3 illustrates a method for establishing a tunnel with the cloud and generating an access code locally at the relay server according to the embodiment of the present inventions. FIG. 3 should be viewed in conjunction with FIG. 1A and FIG. 2A-2C for better understanding.

In process 301, relay server 102, such as network device 220, may determine available clouds that are available to be connected. Each of the available clouds may be a public cloud or a private cloud hosted by the same party. For example, the available clouds are located in the United Kingdom, France, and Brazil.

In process 302, relay server 102 may select a cloud from the available clouds. For example, relay server 102 may select a cloud, such as cloud 103, located in the United Kingdom from the available clouds mentioned in process 301. Details of the cloud selection are described in FIG. 1B.

In one preferred embodiment, selected cloud 103 may be selected by the user or administrator of relay server 102.

In another embodiment, selected cloud 103 may be selected by relay server 102 automatically according to the performance of the at least one second tunnel established between relay server 102 and node 103a.

In process 303, after cloud 103 is selected, relay server 102 may send a first request for connecting a second node through the second interconnected network for establishing at least one second connection, and further, the at least one second tunnel. The second node is a node selected from at least one available node of selected cloud 103, such as node 103a. The at least one available node is determined by scanning all nodes in the selected cloud one-by-one.

In one embodiment, the second node is selected by a node of cloud 103, such as a third node. The third node is capable of performing node selection similar to the node selection performed at relay server 102 and selecting the second node based on the second criterion mentioned before. When the second node is selected, the third node may send a reply corresponding to the request sent by relay server 102. There is no limitation on how the third node is connected to the other nodes of the cloud.

In another embodiment, the second node is randomly selected by the third node of selected cloud 103.

In another embodiment, the second node is selected by relay server 102 based on the second criterion mentioned before.

In another embodiment, the second node is randomly selected by relay server 102.

In one embodiment, when the at least one second tunnel is established, relay server 102 is capable of recovering the lost packets or dropped packets by resending dropped or lost data packets until the node receives the data packets and sends corresponding acknowledgement.

In process 304, relay server 102 may generate an access profile locally. The access profile comprises one or more of the following: at least one tunnel profile with a tunnel identifier, policy, priority, signature, and expiration time.

There is no limitation on the sequence of processes 303 and 304 performed. Process 303 may be followed by process 304, and vice versa.

In one variant, processes 303 and 304 may be performed concurrently.

In process 305, relay server 102 may generate an access code corresponding to the access profile generated at process 304 The access code is stored in a database of the storage unit of relay server 102. There is no limitation on how the access code is stored in the storage unit of relay server 102. The database is adopted for illustrative purposes only.

The access code comprises the access information for both the relay server and the selected cloud. The access information may comprise one or more of the following: MAC address of the relay server, port number associated with the relay server for establishing an IP tunnel between the relay server and the second node, serial number of the relay server, type of encryption, pre-shared key, certificate, location of the selected cloud, designated domain name, username, and password.

The access code may be in any form of the following: a token, a one-dimensional bar code, a two-dimensional bar code (i.e. a QR code), a string, or a numerical string.

There is no limitation on how the access code is being generated. For example, the access code may be generated by hashing the authentication information into a numerical string.

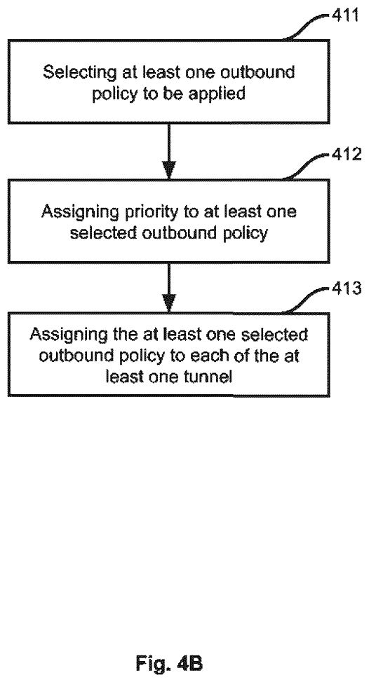

FIG. 4A illustrates a method for establishing the at least one first tunnel between a relay client and a first node with an access code according to the embodiment of the present inventions. FIG. 4A should be viewed in conjunction with FIG. 1A and FIG. 2A-2C for better understanding. When a relay client, such as relay client 101, holds the access code and attempts to establish the at least one first tunnel, process 401 begins.

In process 401, relay client 101 may connect to the selected cloud according to the information of the access code. The access code may comprise information as to the location of the selected cloud to which the relay server 102 is connected.

In process 402, relay client 101 may select the first node from the at least one available node of the selected cloud so that relay client 101 can assess the second node through the first node, and further, relay server 102. For illustrative purposes, the selected cloud is the cloud located in the United Kingdom comprising three management servers, with at least one available node. The at least one available node is determined by scanning all nodes in the selected cloud one-by-one.

The selection of the first node is based on a third criterion. The third criterion may be selected from one or more of the following: latency, packet size, processing rate, location, cost, time, availability, security, and features that the node can perform, such as load balancing.

In another embodiment, the first node is randomly selected by relay client 101.

In one variant, process 402 may be performed by the cloud, instead of relay client 101. Relay client 101 may send a request to the third node of the cloud, which is capable of performing node selection similar to the node selection performed at relay client 101. The third node may select the first node based on the third criterion mentioned before, and send a reply corresponding to the request sent by relay client 101.

For example, the first node is selected according to latency. Assuming that the latency of available nodes 103a, 103b, and 103c are 13 ms, 10 ms, and 22 ms respectively. Therefore, node 103b, which has the least latency, is selected as the first node. If node 103a is the second node to establish at least one second tunnel with relay server 102, then data packets received by relay client 101 may be transmitted to relay server 102 through nodes 103b and 103a.

In process 403, relay client 101 may determine if the second node, and further, the relay server 102, is accessible through the first node. If the second node is not accessible through the first node, then relay client 101 may perform process 402 again until another first node is found such that the second node is accessible. If the second node is accessible through the first node, then process 404 is performed.

In one variant, if there is only one available node within the selected cloud, then relay client 101 may attempt to connect the same node as that connected to relay server 102 in process 403.

In process 404, relay client 101 may establish at least one connection with the first node through the first interconnected network. The number of the at least one connection established may be determined by the number of available network interfaces of relay client 101 and the number of the available network interfaces of the first node. For example, if there are three available WAN interfaces in relay client 101 and only a network interface in the first node, then three connections may be established between relay client 101 and the first node.

In process 405, relay client 101 may attempt to establish the at least one first tunnel with the first node through the at least one first connection.

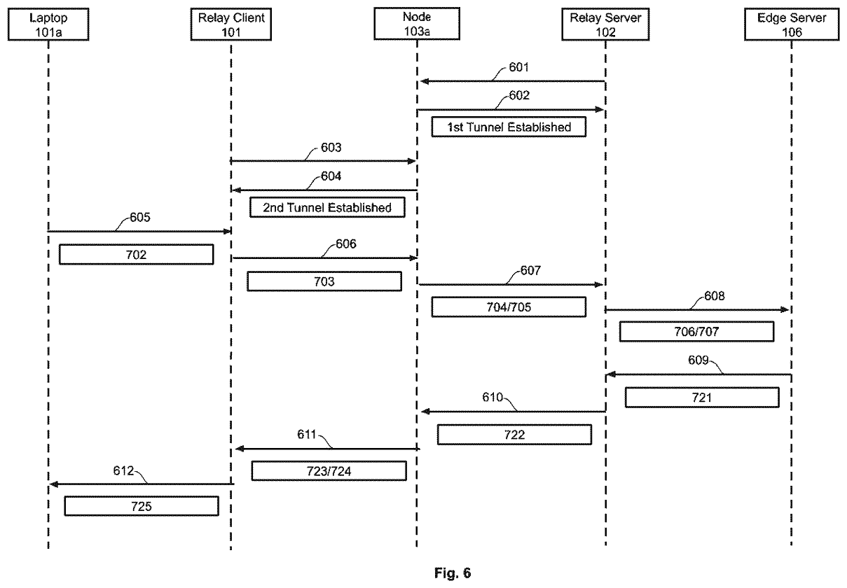

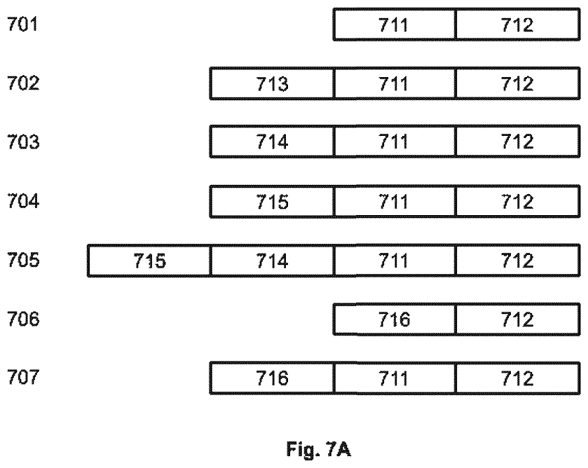

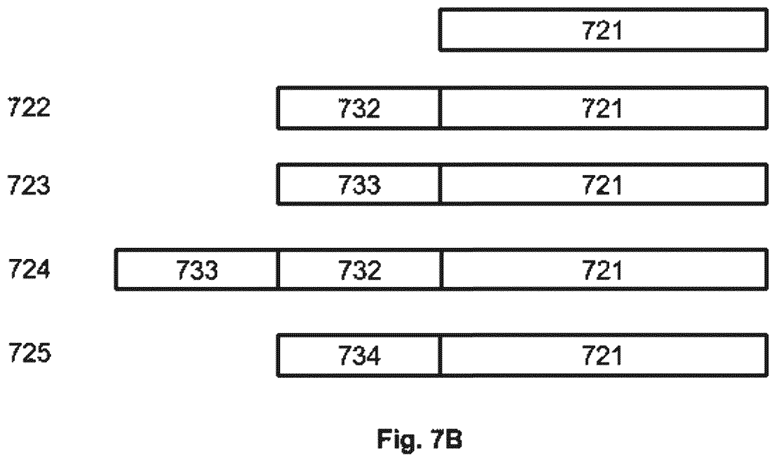

In process 406, when receiving the data packets from a local device, relay client 101 may forward all of the data packets received from the local device to the first node, such as node 103b, along with the path to the data packets' indicated destination. Details of the data packet transmission will be discussed in FIG. 6 and FIG. 7.

In one variant, instead of all data packets, only specific data packets received from the local device may be forwarded to the first node, such as node 103b, along with the path to the data packets' indicated destination.

One or more outbound traffic policies may be performed by relay client 101 in process 406. Therefore, process 407 may be performed after process 405 and followed by process 406, instead of after processes 405 and 406.

Details of process 407 will be discussed in FIG. 4B.

In another variant, relay client 101 may perform process 407 between process 404 and process 405, such that the at least one first tunnel is established only if the at least one outbound traffic policy is applied.

In one embodiment, when the at least one first tunnel is established, relay client 101 is capable of recovering the lost packets or dropped packets by resending dropped or lost data packets until the node receives the data packets and sends corresponding acknowledgement.

FIG. 4B illustrates a method for applying outbound traffic policy among the at least one first connection according to the embodiment of the present inventions. FIG. 4B is a detailed description of process 407, and should be viewed in conjunction with FIG. 1A, FIG. 2A-2C, and FIG. 4A for better understanding.

In process 411, the user or the administrator of relay client 101 may select at least one outbound traffic policy to be applied. The selected at least one outbound traffic policy is used for selecting specific data packets from the received data packets and transmitting them to relay server 102 through the first node and/or the second node.

Instead of all data packets, it is preferable to forward the specific data packets to the relay server through the cloud for traffic optimization. The specific data packets may be selected according to at least one outbound traffic policy defined by a user or administrator of relay client 101. The conditions of the at least one outbound traffic policy may be based on, but not limited to, one or more of the following: the protocol of the data packet, the session of the data packet, the application, source and/or destination port number of the data packet if the data packet is a TCP or UDP segment, the source and/or destination address of the data packet if the data packet is an IP packet, and the time of day.

For illustrative purposes, three outbound traffic policies are selected such that the data packets that satisfy these outbound traffic policies are the specific data packets. The three outbound traffic policies are specific local device based; the local device that is connected to a specific SSID based; and specific local device that belongs to a specific application or session based.

For the local device-based outbound traffic policy, the data packets received from at least one specific local device are the specific data packets to be forwarded to the relay server through the node of the cloud. The condition for determining whether a data packet is received from at least one specific local device may be the source and/or destination port number of the data packet and/or the source and/or destination address of the data packet, such as the MAC address of the source device. For example, as illustrated in FIG. 1A, at least one specific local device may be laptop 101a, which is connected to relay client 101 via a LAN interface of relay client 101. Relay client 101 may be configured to forward the data packets received from laptop 101a to the first node through interconnected network 104, and further to the second node, relay server 102 and the designated device.

For the SSID-based outbound traffic policy, a network device, such as relay client 101, is capable of recognizing a data packet received from a specific SSID by looking at the 802.11 header of the data packet. The 802.11 header contains the SSID of the network that the packet was sent from. Therefore, relay client 101 may forward the data packets received from at least one local device connected to or associated with a specific SSID to the relay server 102 through the node of the cloud. For example, as illustrated in FIG. 1A, laptop 101a is associated with an SSID named “Home”, which is the SSID provided by relay client 101. If relay client 101 is configured to forward the data packets received from the local device via SSID named “Home”, then all the specific data packets received via SSID named “Home” will be transmitted to the first node, the second node, and further to relay server 102 and the designated device.

For the application or session-based outbound traffic policy, there are myriad ways for relay client 101 to recognize a data packet for a specific application or session, such as determining the IP addresses and port numbers in the data packet header, port mirroring, and using deep packet inspection (DPI) to inspect the contents of the data packet. Therefore, relay client 101 may forward the data packets belonging to a specific application or session received from at least one local device to the relay server 102 through the node of the cloud. For example, the specific data packets may be the data packets belonging to a session for Netflix streaming, which is the process of delivering video content to its subscribers over the internet. Relay client 101 may be configured to forward the data packets for Netflix streaming to the second node through interconnected network 104, and further to relay server 102 and the designated device.

In process 412, the user or the administrator of relay client 101 may assign a priority to at least one selected outbound traffic policy. If two or more outbound traffic policies are applied, conflict may be avoided between the outbound traffic policies. The priority of the at least one selected outbound traffic policy may be adjusted by the user or the administrator of relay client 101 anytime and by any means.

In one variant, process 412 may not be performed if there is only one outbound traffic policy to be selected.

In process 413, relay client 101 may assign the at least one selected outbound traffic policy to each of the at least one first tunnel or each of the at least one first tunnel to be established.

In one embodiment, one or more outbound traffic policies can be assigned to one connection.

In another embodiment, only one connection can be associated with one outbound traffic policy.

After process 413, when receiving the data packets from a local device, relay client 101 may forward the data packets received from the local device to the first node in process 406. The forwarding is based on the at least one selected outbound traffic policy and the priority of the at least one selected outbound traffic policy.

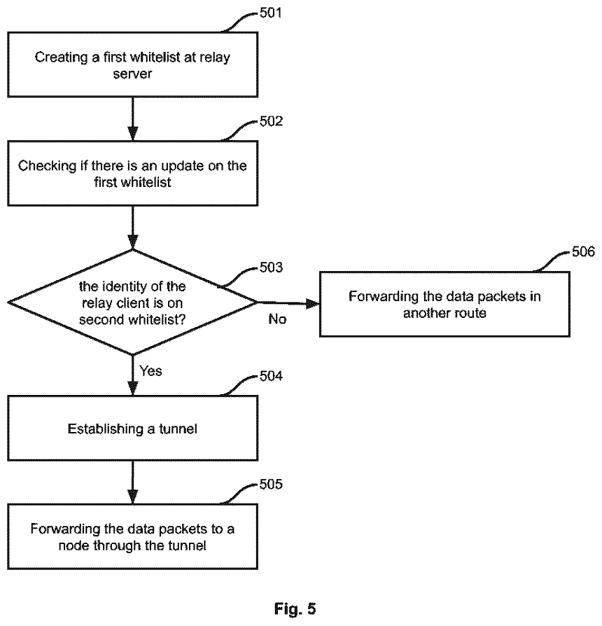

In general, it is possible for any relay clients to connect with the relay server through a node of a selected cloud if the relay clients possess the access code. Therefore, it is possible for the local devices connected to the relay clients to connect with the relay server through the node. For security purposes, access control may be introduced on the relay server side and the node such that the access by the relay clients can be controlled. FIG. 5 is a flow diagram illustrating how the access control is implemented on the relay server side and the node to make use of an access control list.

The access control list may be a whitelist or a blacklist. If the access control list is implemented as a whitelist, then only the relay clients listed on the whitelist are allowed to be accessed through the second node.

On the contrary, if the access control list is implemented as a blacklist, then all relay clients are allowed to be accessed through the second node except relay clients listed on the blacklist. For illustrative purposes, the access control list is implemented as a whitelist in the following process for easier understanding.

In process 501, a first whitelist is created at the relay server, such as relay server 102. The first whitelist is stored on the storage unit of relay server 102 and managed by the user or the administrator of relay server 102. The first whitelist can be implemented as any of the following: database, parameters, and text strings or any other means that can store the MAC address, the IP address, domain name, port, and/or URL.

There is no limitation on how the whitelist or the blacklist is being implemented. The whitelist or the blacklist can be implemented by any means, such as MAC address filtering, IP address filtering, domain name filtering, port filtering, and URL filtering.

An identity of an allowed relay client may be recorded on the first whitelist, which should be a unique parameter, such as the serial number of a relay client. The serial number of the allowed relay client mentioned here is for illustrative purposes only, the identity may be any unique parameter allowing identification of an allowed relay client.

The number of allowed relay clients may be zero or more than zero. If the number of the allowed relay clients is zero, that means no identity is inputted into the first whitelist and no relay clients are allowed for access.

In one preferred embodiment, the access control of the first whitelist may be applied to the configuration of all access codes generated by the relay server. For example, only the allowed relay clients on the first whitelist are allowed to access the relay server through any of the access codes generated by the relay server.

In another embodiment, the access control of the first whitelist may be applied to the configuration of a particular access code generated by the relay server. For example, if the first whitelist is applied to the particular access code generated by the relay server, then only the allowed relay clients on the first whitelist are allowed to access the relay server through the particular access code generated by the relay server.

In process 502, the relay server may check if there is an update on the first whitelist. The update may include the operation of creating, adding, deleting, amending, and replacing.

In one preferred embodiment, a second whitelist is stored on the first node or the second node for updating or synchronizing the first whitelist. When there is an update on the first whitelist, the first whitelist may synchronize with the second whitelist instantaneously.

In another embodiment, no whitelist is stored on the first node or the second node. The first node or the second node may confirm with the first whitelist stored on the relay server upon demand.

In one variant, the updating or the synchronization may be performed periodically or by batch for updating the second whitelist. For example, the second whitelist may be updated within a predetermined time, such as every hour, every day, or every month.

In another variant, the updating or the synchronization may be performed at the first node or the second node. The first node or the second node may check if there is an update on the second whitelist on the first node or the second node. If no update was received on the second whitelist, the first node or the second node may synchronize with the relay servers that are connected to the first node or the second node to update the second whitelist.

In process 503, at the first node or the second node, when receiving a second request for establishing a tunnel from the relay client, the first node or the second node may determine if the identity of the relay client is on the second whitelist.

If the identity of the relay client is on the second whitelist, which is stored at the first node or the second node, establish a tunnel in process 504. and forward the data packets received from the relay client to the relay server through the selected cloud in process 505.

If the identity of the relay client is not on the second whitelist, forward the data packets received from the relay client to the relay server through another route in process 506.

FIG. 6 is a timing diagram that illustrates how the connections are established between the relay client and the relay server through at least one node of the selected cloud by using the access code. FIG. 6 should be viewed in conjunction with FIG. 1A, FIG. 3, and FIG. 4A for an overall picture and a better understanding of the embodiments of the present inventions.

In process 601, as illustrated in process 303 of FIG. 3, relay server 102 may connect to the second node, such as node 103a, of the selected cloud, such as cloud 103, located in the United Kingdom. Relay server 102 may send a first request to node 103a for establishing the at least one first tunnel with node 103a.

In process 602, node 103a may send a first reply to relay server 102 corresponding to the first request sent from relay server 102 to node 103a at process 601. After the first reply is received, the at least one second tunnel is established between relay server 102 and node 103a, and an access code is generated at relay server 102 locally. There is no limitation as to the method how relay client 101 obtains the access code generated by relay server 102. By using the access code, relay client 101 is capable of establishing the at least one first tunnel with the first node of the selected cloud in processes 603 and 604.

In process 603, similar to process 404 as illustrated in FIG. 4A, relay client 101 may establish at least one first tunnel with the first node, such as node 103a, of the selected cloud. Relay client 101 may send a second request to node 103b to establish the at least one first tunnel with node 103a. The second node is a node of the selected cloud that relay server 101 is connected to.

For simplification, relay client 101 and relay server 102 are connected to the same node such that the first node and the second node are the same node, such as node 103a. Both the first node and the second node are capable of performing routing, decapsulation, and encapsulation functions. If the first node is different from the second node, at least part of the encapsulation and the decapsulation is performed as described in FIG. 6 on either the first node or the second node.

In one variant, access control may be applied when establishing the at least one first tunnel. Node 103a may check the record of the access control list before sending a second reply to relay client 101 in process 604. The access control list may be a whitelist or a blacklist stored in either node 103a or relay server 102. If the identity of relay client 101 is not recorded on the whitelist or is recorded on the blacklist, then the establishment of the at least one first tunnel is not allowed.

In process 604, node 103a may send a second reply to relay client 101, and the at least one first tunnel is then established. The second reply corresponds to the second request sent from relay client 101 to node 103a at process 603.

After the at least one first tunnel and the at least one second tunnel are established, relay client 101 may transmit specific data packets to relay server 102 through node 103a. The overall transmission is illustrated in process 605-608 at FIG. 6, and should be viewed in conjunction with FIG. 7A for better understanding.

There is no limitation on the number of tunnels of the at least one first tunnel established between relay server 102 and node 103a, and the number of tunnels of the at least one second tunnel established between relay client 101 and node 103a; the number of tunnels established may be varied in accordance with the number of network interface on each side, and the user preference. For illustrative purposes, only a single tunnel is established between relay client and the node of the cloud, and between relay server and the node of the cloud.

Before process 605, a first data packet, such as first data packet 701, is to be transmitted from laptop 101a to edge server 106, which may be a datagram comprising a third request for requesting data or information from edge server 106. Therefore, the first data packet, such as first data packet 701, is encapsulated as a first encapsulated data packet, such as first encapsulated data packet 702.

In process 605, the first encapsulated data packet is transmitted to a network interface of relay client 101 through the at least one connection. In one embodiment, the first encapsulated data packet may be received wirelessly or via wired connection(s) from laptop 101a through a LAN interface of relay client 101.

In another embodiment, the first encapsulated data packet may be received wirelessly or via wired connection(s) from laptop 101a through a different WAN interface of relay client 101.

In process 606, a second encapsulated data packet, such as second encapsulated data packet 703, is transmitted to node 103a when receiving the first encapsulated data packet from the local device. Relay client 101 may encapsulate the first encapsulated data packet to form the second encapsulated data packet, and may check if a condition is satisfied. The encapsulation will be discussed in FIG. 7A and FIG. 7B.

If the condition is satisfied, relay client 101 may transmit the second encapsulated data packet to node 103a through an established tunnel. The condition is satisfied if the received first encapsulated data packet is the specific data packet as mentioned before. For example, the specific data packet may be a data packet received from a local device connected to a specific SSID, received from a local device with a specific identifier, or under a specific session.

If the condition is not satisfied, relay client 101 may then transmit the second encapsulated data packet through another route. The condition is not satisfied if the connection is not established between the relay client and the node 103a of the selected cloud. One of the possible reasons why the connection is not established is access control. For example, the identity of relay client 101 is not on the whitelist or is on the blacklist.

In process 607, the third or fourth encapsulated data packet is transmitted from node 103a to relay server 102. When receiving the second encapsulated data packet through a first interconnected network, node 103a may decapsulate the second encapsulated data packet, and then encapsulate the payload of the second encapsulated data packet as third encapsulated data packet, and forward the third encapsulated data packet to relay server 102 according to the destination address in the header.

In one variant, node 103a may further encapsulate the second encapsulated data packet as a fourth encapsulated data packet, which comprises the same transport protocol header with the third encapsulated data packet.

In process 608, the second data packet or the fifth encapsulated data packet is transmitted from relay server 102 to edge server 106. When receiving the third or fourth encapsulated data packet from the node of the selected cloud through a second interconnected network, relay server 102 may decapsulate the third or fourth encapsulated data packet to determine which device the first data packet should be designated according to the designated address of the first data packet, and further forward a second data packet or a fifth encapsulated data packet to the designated device. The second data packet and the fifth encapsulated data packet are corresponding to second data packet 706 and fifth encapsulated data packet 707 as illustrated in FIG. 7A respectively.

In order to achieve the methods and the disclosures in the present invention, the prerequisites as to the location of each device must be fulfilled. Through applying the data packet transmission process disclosed in the present invention, the data packet received by edge server 106 may be treated as the data packet being sent from relay server 102 instead of relay client 101, and is deemed as a local connection.

After sending the third request to edge server 106, relay server 102 is expected to receive a response corresponding to the third request.

In process 609, a third data packet is transmitted from edge server 106 to relay server 102. For example, the third data packet may be a datagram comprising a response for responding the third request to laptop 101a.

In process 610, a sixth encapsulated data packet is transmitted from relay server 102 to node 103a. When the third data packet, such as third data packet 721, is received by relay server 102, relay server 102 may determine if the payload of third data packet 721 corresponds to the payload of first data packet 701. For example, the payload of third data packet 721 is a response corresponding to the request, which is the payload of first data packet 701. Therefore, relay server 102 may encapsulate the third data packet as a sixth encapsulated data packet, such as sixth encapsulated data packet 722, and transmit the sixth encapsulated data packet to node 103a.

In process 611, a seventh or eighth encapsulated data packet is transmitted from node 103a to relay client 101. When receiving the sixth encapsulated data packet from relay server 102 through a second interconnected network, node 103a may decapsulate the third data packet from the sixth encapsulated packet, and then encapsulate the third data packet as the seventh encapsulated data packet, such as seventh encapsulated data packet 723, and forward the seventh encapsulated data packet to relay client 101 through the first node.

In another variant, no decapsulation is performed at node 103a. Instead, the node 103a may further encapsulate the sixth encapsulated data packet to form the eighth encapsulated data packet, such as eighth encapsulated data packet 724, which comprises the same transport protocol header as the seventh encapsulated data packet.

In process 612, a ninth encapsulated data packet, such as ninth encapsulated data packet 725, is transmitted from relay client 101 to laptop 101a. When receiving the seventh or eighth encapsulated data packet from node 103a through a first interconnected network, relay client 101 may decapsulate the third data packet from the received encapsulated data packet. Relay client 101 then encapsulates the third data packet to form the ninth encapsulated data packet. This ninth encapsulated data packet is then further forwarded to laptop 101a.

When data packets are transmitted between the relay client and the relay server, the data packets are encapsulated to form encapsulated packets.

When the encapsulated packets have arrived at the end of the tunnels, the encapsulated data packets can then be decapsulated and data packets can be extracted.

FIG. 7A illustrates the relationship between the data packets and the encapsulated packets during process 605-608. For illustration purposes only, when laptop 101a transmits first data packet 701 to edge server 106, the following processes will take place.

First data packet 701 has header 711 and payload 712. Header 711 is used to store source address, destination address, protocol type, length of the packet, and other information. Payload 712 is used to hold data that laptop 101a intends to send to edge server 106. In this illustration, the source address is the address of laptop 101a and the destination address is the address of edge server 106. Those who are skilled in the arts would appreciate that first data packet 701 can be an IP packet, Ethernet frame, X.25 packet, and etc.

In process 605, laptop 101a transmits first encapsulated data packet 702 to relay client 101. First encapsulated data packet 702 has header 713 and a first payload section. Header 713 contains a destination address field set to be the address of a network interface of relay client 101 and a source address field set to be the address of a network interface of laptop 101a. The first payload section of first encapsulated data packet 702 is used to hold first data packet 701.

In process 606, relay client 101 may transmit second encapsulated data packet 703 to node 103a. Second encapsulated data packet 703 has header 714 and a second payload section. Header 714 contains a destination address field set to be the address of a network interface of the first node and a source address field set to be the address of a network interface of relay client 101. The second payload section is used to hold first data packet 701.

In process 607, node 103a may transmit the third encapsulated data packet to relay server 102. Similar to first encapsulated data packet 702 and second encapsulated data packet 703, third encapsulated data packet 704 has header 715 and a payload section. Header 715 contains a destination address field set to be the address of a network interface of relay server 102 and a source address field set to be the address of a network interface of node 103a. The payload section is used to hold first data packet 701.

In one variant, no decapsulation is performed at node 103a. Instead, node 103a may encapsulate second encapsulated data packet 703 in fourth encapsulated data packet 705, and transmit fourth encapsulated data packet 705 to relay server 102. Similar to third encapsulated data packet 704, fourth encapsulated data packet 705 has header 715 and a payload section.

Header 715 is the same header of third encapsulated data packet 704, but a different payload of third encapsulated data packet 704. The payload section is used to hold second encapsulated data packet 703.

Before process 608, when third encapsulated data packet 704 or fourth encapsulated data packet 705 is received by relay server 102, relay server 102 then decapsulates first data packet 701 from third encapsulated data packet 704 or fourth encapsulated data packet 705.

In process 608, relay server 102 may transmit fifth encapsulated data packet 716 to edge server 106. Fifth encapsulated data packet 707 has header 716 and a payload section. Header 716 contains a destination address field set to be the address of a network interface of edge server 106 and a source address field set to be the address of a network interface of relay server 102. The payload of fifth encapsulated data packet 707 is used to hold first data packet 701.

In one variant, relay server 102 may transmit the second data packet to edge server 106 instead of fifth encapsulated data packet 716. Second data packet 706 has the same header 716 as fifth encapsulated data packet 707, but is different in payload. The payload of second data packet 706 is used to hold the payload of first data packet 701.

FIG. 7B illustrates the relationship between the data packets and the encapsulated packets during processes 609-612, which illustrate the data transmission from host 106 back to laptop 101a.

In process 610, relay server 102 may transmit sixth encapsulated data packet 722 to node 103a. Sixth encapsulated data packet 722 has header 732 and a payload section. Header 732 contains a destination address field set to be the address of a network interface of the second node and a source address field set to be the address of a network interface of relay server 102. The payload section is used to hold third data packet 721.

In process 611, node 103a may transmit seventh encapsulated data packet 723 to relay client 101. Seventh encapsulated data packet 723 has header 733 and a payload section. Header 733 contains a destination address field set to be the address of relay client 101 and a source address field set to be the address of a network interface of the second node The payload section is used to hold third data packet 721. The second node then transmits seventh encapsulated data packet 723 to relay client 101 using a previously established tunnel through a first interconnected network.

In one variant, in process 611, node 103a may transmit eighth encapsulated data packet 724 to relay client 101. Eighth encapsulated data packet 724 has header 733 and a payload section. Header 733 is the same header as of seventh encapsulated data packet 723. However, the payload section is used to hold sixth encapsulated data packet 722. The second node then transmits eighth encapsulated data packet 724 to relay client 101 using a previously established tunnel through a first interconnected network.

In process 612, Relay client 101 forwards ninth encapsulated data packet 725 to laptop 101a. Ninth encapsulated data packet 725 has header 734 and a payload section. Header 734 contains a destination address field set to be the address of laptop 101a and a source address field set to be the address of a network interface of edge server 106. The payload of ninth encapsulated data packet 725 is used to hold third data packet 721.

In one embodiment, VPN ID may be introduced for the data packet transmission, which is an identification string randomly generated by the network device and guaranteed to be unique.

One of the benefits for introducing VPN ID is to assist data packet routing at the nodes of the cloud. It is possible that relay client 101 or relay server 102 may send out the data packets through an IP address but receive the corresponding data packets through another IP address if the data packets are transmitted via the tunnel through more than one WAN connections established between relay client 101 and interconnected network 104, or relay server 102 and interconnected network 105 respectively.

The generated VPN ID is part of the header or part of the payload of the data packet, which is for the node of the selected cloud to recognize how the data packet is transmitted or routed. During data packet transmission, the VPN ID may be stored on a node's database of the selected cloud. The node may be the first node or the second node described herein.

In one variant, in process 611, node 103a may transmit eighth encapsulated data packet 724 to relay client 101. Eighth encapsulated data packet 724 has header 733 and a payload section. Header 733 is the same header as of seventh encapsulated data packet 723. However, the payload section is used to hold sixth encapsulated data packet 722. The second node then transmits eighth encapsulated data packet 724 to relay client 101 using a previously established tunnel through a first interconnected network.

In process 612, Relay client 101 forwards ninth encapsulated data packet 725 to laptop 101a. Ninth encapsulated data packet 725 has header 734 and a payload section. Header 734 contains a destination address field set to be the address of laptop 101a and a source address field set to be the address of a network interface of edge server 106. The payload of ninth encapsulated data packet 725 is used to hold third data packet 721.

In one embodiment, VPN ID may be introduced for the data packet transmission, which is an identification string randomly generated by the network device and guaranteed to be unique.

One of the benefits for introducing VPN ID is to assist data packet routing at the nodes of the cloud. It is possible that relay client 101 or relay server 102 may send out the data packets through an IP address but receive the corresponding data packets through another IP address if the data packets are transmitted via the tunnel through more than one WAN connections established between relay client 101 and interconnected network 104, or relay server 102 and interconnected network 105 respectively.

The generated VPN ID is part of the header or part of the payload of the data packet, which is for the node of the selected cloud to recognize how the data packet is transmitted or routed. During data packet transmission, the VPN ID may be stored on a node's database of the selected cloud. The node may be the first node or the second node described herein.

1. A method for establishing at least one connection between a first network device and a second network device, comprising:
a. at the second network device, selecting a cloud;
b. at the second network device, establishing at least one first connection with a first node;
c. at the second network device, generating an access code locally;
d. at the first network device, by using the access code, establishing at least one second connection with a second node;
e. at the first network device, forwarding a first data packet received from a local device to the second node;
f. at the second network device, receiving a second data packet;
wherein:
the first data packet is part of the payload of the second data packet;
the access code comprises the access information for both the second network device and the selected cloud;
each of the first node and the second node is one of the at least one available node of the selected cloud; and
the first node and the second node are capable of exchanging data and information.

2. The method of claim 1, wherein the first data packet is forwarded to the second node in step e if a first condition is satisfied.

3. The method of claim 2, wherein the first condition is satisfied if the first network device is on an access control list.

4. The method of claim 3, wherein the access control list is stored in the first node of the selected cloud.

5. The method of claim 1, wherein the first node and the second node are the same node.

6. The method of claim 1, wherein the second node is selected based on a criterion.

7. The method of claim 1, wherein the access code is in any form of the following: a token, a one-dimensional bar code, a two-dimensional bar code, a string, or a numerical string.

8. The method of claim 1, further comprises:
assigning an outbound traffic policy to each of the established at least one second connection.

9. The method of claim 1, wherein the second data packet comprises an IP header, wherein the IP header of the second data packet is different from the IP header of the first data packet.

10. The method of claim 1, wherein encapsulation and decapsulation are performed during the forwarding in step e.

11. A system for establishing at least one connection between a first network device and a second network device, comprising:
a second network device, comprising:
at least one second processing unit;
a plurality of second network interfaces; and
at least one second non-transitory computer readable storage medium storing program instructions executable by the at least one second processing unit for:
a. selecting a cloud;
b. establishing at least one first connection with a first node;
c. generating an access code locally; and
d. receiving a second data packet; and
a first network device, comprising:
at least one first processing unit;
a plurality of first network interfaces; and
at least one first non-transitory computer readable storage medium storing program instructions executable by the at least one first processing unit for:
e. establishing at least one second connection with a second node using an access code; and
f. forwarding a first data packet received from a local device to the second node;
wherein:
the first data packet is part of the payload of the second data packet;
the access code comprises the access information for both the second network device and the selected cloud;
each of the first node and the second node is one of the at least one available node of the selected cloud; and
the first node and the second node are capable of exchanging data and information.

12. The system of claim 11, wherein the first network device forwards the first data packet received from a local device to the second node in step f if a first condition is satisfied.

13. The system of claim 12, wherein the first condition is satisfied if the first network device is on an access control list.

14. The system of claim 13, wherein the access control list is stored in the first node of the selected cloud.

15. The system of claim 11, wherein the first node and the second node are the same node.

16. The system of claim 11, wherein the second node is selected based on a criterion.

17. The system of claim 11, wherein the access code is in any form of the following: a token, a one-dimensional bar code, a two-dimensional bar code, a string, or a numerical string.

18. The system of claim 11, wherein the at least one first non-transitory computer readable storage medium further stores program instructions executable by the at least one first processing unit for:
assigning an outbound traffic policy to each of the established at least one second connection.

19. The system of claim 11, wherein the second data packet comprises an IP header, wherein the IP header of the second data packet is different from the IP header of the first data packet.

20. The system of claim 11, wherein encapsulated and decapsulation are performed by the first network device during the forwarding in step f.
